(19) United States
(12) Patent Application Publication
(10) Pub. No.: US 2026/0272026 A1
(43) Pub. Date: Sep. 17, 2026

(54) AEROSOL-GENERATING CARTRIDGE

(71) Applicant: Philip Morris Products S.A., Neuchatel (CH)

(72) Inventors: Chiara FASCIANI, Basel (CH); Ruilong HU, Shenzhen (CN); Bo JIANG, Oberkirch (CH); Patrick Charles SILVESTRINI, Neuchâtel (CH); Baofeng XIE, Shenzhen (CN)

(73) Assignee: Philip Morris Products S.A., Neuchatel (CH)

(21) Appl. No.: 19/473,284

(22) PCT Filed: Apr. 14, 2023
(86) PCT No.: PCT/CN2023/088428

§ 371 Date: Oct. 7, 2025

(51) Int. Cl. A24F 40/46; A24F 7/00; A24F 40/10; A24F 40/42; A24F 40/44; A24F 40/485; H05B 3/03

(52) U.S. Cl. CPC A24F 40/46; A24F 7/00; A24F 40/10; A24F 40/42; A24F 40/44; A24F 40/485; H05B 3/03; H05B 2203/021

(57) ABSTRACT

An aerosol-generating cartridge is provided, including: aerosol outlet and connection ends and a longitudinal direction extending between the ends; a mouthpiece including a mouthpiece housing having a mouthpiece housing length in the direction, and a mouthpiece housing width and thickness, the housing width being greater than the thickness; a heater in the housing and including: a heating element to vaporise a liquid aerosol-forming substrate, and a porous body to convey the substrate to the element and having a heating surface facing the air outlet, the heating element being located on the heating surface; an aerosol outlet at the aerosol outlet end; and an air inlet between the outlet and connection ends, the air inlet being in fluid communication with the aerosol outlet to define an airflow pathway through the housing, the airflow pathway extending from the heating element to the aerosol outlet in the longitudinal direction of the cartridge.

The invention relates to an aerosol-generating cartridge. The invention also relates to an aerosol-generating system comprising the cartridge.

Aerosol-generating systems that heat a liquid aerosol-generating substrate in order to generate an inhalable aerosol for delivery to a user are known. In particular, handheld electrically operated aerosol-generating systems comprising a replaceable cartridge comprising a liquid storage portion containing a supply of liquid aerosol-generating substrate and an electrically operated heater configured to heat the liquid aerosol-generating substrate to generate an inhalable aerosol are known. Such known handheld electrically operated aerosol-generating systems typically also comprise a reusable aerosol-generating device comprising control circuitry and a power source for supplying power to the electrically operated heater.

The electrically operated heater typically comprises a resistive heating element in the form of a coil of wire that is wound around an elongate wick, which transports liquid aerosol-generating substrate from the liquid storage portion of the cartridge to the coil of wire. In use, an electric current is passed through the coil of wire to heat the liquid aerosol-generating substrate to generate an inhalable aerosol that is drawn into the mouth of a user by way of a mouthpiece.

In other known handheld electrically operated aerosol-generating systems, the electrically operated heater comprises a resistive heating element located on a heating surface of a porous body, which transports liquid aerosol-generating substrate from the liquid storage portion of the cartridge to the resistive heating element.

Handheld electrically operated aerosol-generating systems of the type described above have been found to have a number of drawbacks. One of them is “dry heating” or “dry puff”. To ensure that a satisfactory aerosol is produced, it is preferable to maintain a sufficient supply of liquid aerosol-generating substrate to the heating element during operation to keep the heating element in a wet state. Dry heating arises where an electric current is passed through the heating element when insufficient liquid aerosol-generating substrate is being supplied to the heating element. Dry heating may, for example, occur when the supply of liquid aerosol-generating substrate in the liquid storage portion of the cartridge has been depleted. Dry heating may result in overheating of the heating element. This may lead to thermal decomposition of the liquid aerosol-generating substrate. Thermal decomposition of the liquid aerosol-generating substrate may produce undesirable by-products. Thermal decomposition of the liquid aerosol-generating substrate may result in the production of an unsatisfactory aerosol. Continued operation of an aerosol-generating system when insufficient liquid aerosol-generating substrate is being supplied to the heating element may thereby result in a poor user experience.

In one known handheld electrically operated aerosol-generating system of the type described above there is a mouthpiece having a length in the longitudinal direction of the system, and having a width and a thickness, the width being greater than the thickness. In this known system, the heater is a porous body having a heating element on a heating surface facing the air outlet. In this known system, the airflow pathway through the system is configured such that airflow approaches an absorption surface of the heater before passing around to the heating surface, where the airflow entrains vapour before passing to the aerosol outlet. The inventors have identified that in this known system, vapour condenses by an amount which provides an unsatisfactory user experience. The inventors have identified that a system or cartridge in which there is less condensation, would provide an improved user experience.

The invention relates to an aerosol-generating cartridge. The aerosol-generating cartridge may comprise an aerosol outlet end. The aerosol-generating cartridge may comprise a connection end. The aerosol-generating cartridge may comprise a longitudinal direction extending between the aerosol outlet end and the connection end. The aerosol-generating cartridge may comprise a mouthpiece. The mouthpiece may comprise a mouthpiece housing. The mouthpiece housing may have a mouthpiece housing length in the longitudinal direction. The mouthpiece housing may have a mouthpiece housing width. The mouthpiece housing may have a mouthpiece housing thickness. The mouthpiece housing width may be greater than the mouthpiece housing thickness. The aerosol-generating cartridge may comprise a heater. The heater may be arranged in the mouthpiece housing. The heater may comprise a heating element. The heating element may be for vaporising a liquid aerosol-forming substrate. The heater may comprise a porous body. The porous body may be for conveying the liquid aerosol-forming substrate to the heating element. The porous body may have a heating surface. The heating surface may face the air outlet. The heating element may be located on the heating surface of the porous body. The aerosol-generating cartridge may comprise an aerosol outlet. The aerosol outlet may be at the aerosol outlet end. The aerosol-generating cartridge may comprise an air inlet between the aerosol outlet end and the connection end. The air inlet may be in fluid communication with the aerosol outlet. The air inlet may be in fluid communication with the aerosol outlet to define an airflow pathway, which may also be referred to as an airflow passage. The air inlet may be in fluid communication with the aerosol outlet to define an airflow pathway through the mouthpiece housing. The airflow pathway may extend from the heating element. The airflow pathway may extend from the heating element to the aerosol outlet. The airflow pathway may extend from the heating element to the aerosol outlet in the longitudinal direction of the cartridge. The heater may have a heater length in the longitudinal direction. The heater may have a heater width. The heater may have a heater thickness. The heater width may be greater than the heater thickness. The heater may be oriented such that the heater width extends in substantially the same direction as the mouthpiece housing width.

According to the invention, there is provided an aerosol-generating cartridge. The aerosol-generating cartridge comprises: an aerosol outlet end, a connection end, and a longitudinal direction extending between the aerosol outlet end and the connection end; a mouthpiece comprising a mouthpiece housing having a mouthpiece housing length in the longitudinal direction, a mouthpiece housing width and a mouthpiece housing thickness, the mouthpiece housing width being greater than the mouthpiece housing thickness; a heater arranged in the mouthpiece housing, the heater comprising: a heating element for vaporising a liquid aerosol-forming substrate; and a porous body for conveying the liquid aerosol-forming substrate to the heating element, the porous body having a heating surface facing the air outlet, the heating element being located on the heating surface of the porous body, an aerosol outlet at the aerosol outlet end, and an air inlet between the aerosol outlet end and the connection end; the air inlet being in fluid communication with the aerosol outlet to define an airflow pathway through the mouthpiece housing, the airflow pathway extending from the heating element to the aerosol outlet in the longitudinal direction of the cartridge, wherein the heater has a heater length in the longitudinal direction, a heater width and a heater thickness, the heater width being greater than the heater thickness, and the heater is oriented such that the heater width extends in substantially the same direction as the mouthpiece housing width.

In a cartridge in which the air inlet is provided between the aerosol outlet end and the connection end, air passing through the airflow pathway from the inlet does not need to pass entirely around the porous body from a liquid absorption side of the porous body to the heating surface of the porous body. Instead, air flow can approach the heater in a lateral direction, from a side of the cartridge. This arrangement has fewer airflow turning points adjacent to the heater. This arrangement provides a smooth airflow which can entrain vapour quickly, and prevents a large amount of vapour staying in the aerosol generation chamber which reduces the amount of condensation in the aerosol generation chamber. This provides a more suitable aerosol at the aerosol outlet, and provides an improved user experience.

In addition, provision of the heating surface of the heater facing the aerosol outlet allows for a direct path for aerosol to the aerosol outlet. This reduces the amount of condensation and provides a more suitable aerosol at the aerosol outlet, providing an improved user experience.

As used herein, the term “aerosol-generating device” relates to a device that interacts with a liquid aerosol-forming substrate to generate an aerosol.

As used herein, the terms “cartridge” and “aerosol-generating cartridge” relate to a component that interacts with a liquid aerosol-forming device to generate an aerosol. An aerosol-generating cartridge contains, or is configured to contain, a liquid aerosol-forming substrate.

As used herein, the term “porous” refers to a component which has a plurality of pores. At least some of the pores are open-cell pores. At least some of the pores are interconnected such that liquid can pass through the porous component.

As used herein, the term “heating element” refers to a component which transfers heat energy to the liquid aerosol-forming substrate.

As used herein, the term “aerosol-generating substrate” is used to describe a substrate comprising aerosol-generating material that is capable of releasing upon heating volatile compounds that can generate an aerosol.

As used herein, the term “liquid aerosol-forming substrate” relates to a liquid substrate capable of releasing volatile compounds that can form an aerosol. Such volatile compounds can be released by heating the aerosol-forming substrate.

As used herein, the term “aerosol” is used to describe a dispersion of solid particles, or liquid droplets, or a combination of solid particles and liquid droplets, in a gas. The aerosol may be visible or invisible. The aerosol may include vapours of substances that are ordinarily liquid or solid at room temperature as well as solid particles, or liquid droplets, or a combination of solid particles and liquid droplets.

As used herein, the terms “proximal” and “distal” are used to describe the relative positions of components, or portions of components, of aerosol-generating cartridges according to the invention.

Systems and cartridges comprise a proximal end through which, in use, an aerosol exits the cartridge or system. Cartridges comprise a distal end opposite the proximal end. The proximal end of the cartridge may also be referred to as the mouth end or downstream end. The distal end of the cartridge may also be referred to as the upstream end.

As used herein, the term “fixedly attached” is used to describe a physical attachment which cannot be unattached or disconnected by a user during normal use. Two parts or components may be fixedly attached directly to each other, in which case they are in direct contact. Two parts or components may be fixedly attached directly to each other, in which case they are connected via another intermediate component.

The terms “length”, “width” and “thickness” are used to describe dimensions relative to a length, width and thickness of the overall system. The length of the system is the longest dimension of the system measured along a longitudinal axis, from a proximal end of the system to a distal end of the system. This may be an axis extending through the aerosol outlet at the proximal end of the system. The width and thickness dimensions of the system are measured at the aerosol outlet. The thickness direction along which the thickness is measured is perpendicular to the width direction along which the width is measured. The longitudinal direction along which the length is measured is perpendicular to the width direction and to the thickness direction. For the system, the length is greater than the width, and the width is greater than the thickness.

For any dimension, the dimension defined is taken to be the maximum dimension in a particular direction. For example, as used herein, the “length” of the porous body is used to describe the maximum dimension of the porous body in the longitudinal direction of the system. That is, the maximum dimension of the porous body in the direction between the heating surface and the liquid absorption surface of the porous body, along the longitudinal axis of the system. Equally, the “width” of the porous body is the maximum dimension of the porous body in the width direction of the system.

For any part or component of the system, the length, width and thickness dimensions of that part or component are measured relative to the longitudinal, width and thickness directions set by the system. For any part of the system, the length of that part may be smaller than the width or the thickness of that part.

The aerosol-generating cartridge may comprise an enclosed airflow pathway, extending from the one or more air inlets to one or more aerosol outlets. The enclosed airflow pathway may extend from the one or more air inlets, past the heater, to the one or more aerosol outlets.

The cartridge may define an aerosol generation chamber. The aerosol generation chamber may be adjacent to the heating element. The aerosol generation chamber may be at a proximal side of the heater. The aerosol generation chamber may be at a proximal side of the heating element. The airflow pathway may be configured to approach the aerosol generation chamber in a width direction or thickness direction of the mouthpiece.

The air inlet may be disposed at a longitudinal position between the longitudinal positions of the connection end of the cartridge and the aerosol outlet.

The air inlet may be located such that the airflow pathway does not pass in a longitudinal direction past the connection end of the cartridge.

The air inlet may be closer to the aerosol outlet than a connection end of the cartridge.

The airflow pathway may comprise one or more turns. The airflow pathway may be configured such that from the air inlet to the aerosol outlet, the airflow pathway does not turn away from the aerosol inlet. The airflow pathway may be configured such that the or each turn allows air to either: stay at the same longitudinal position, or flow closer to the aerosol outlet.

The airflow pathway may me configured such that the heater is not directly between the aerosol outlet and any part of the airflow pathway. The airflow pathway may be configured to not extend towards a distal surface of the heater. The airflow pathway may be configured to not surround the heater in a longitudinal direction.

The aerosol-generating cartridge may comprise a first airflow pathway that extends from the one or more air inlets towards the heater in a first direction. The aerosol-generating cartridge may comprise a second airflow pathway that extends past the resistive heating element. The second airflow pathway may extend through the aerosol generation chamber. The aerosol-generating cartridge may comprise a third airflow pathway that extends from the heater to the one or more aerosol outlets in a second direction. The first airflow pathway may be in a plane aligned with a plane in which the second airflow pathway extends. The third airflow pathway may extend in a substantially perpendicular direction to the first airflow pathway. The third airflow pathway may extend in a substantially perpendicular direction to the second airflow pathway. The third airflow pathway may be an aerosol pathway. The second airflow pathway may provide a fluid connection between the first airflow pathway and the third airflow pathway.

The aerosol-generating system may be configured such that air flow past the heater entrains liquid aerosol-generating substrate vaporised by the resistive heating element.

The mouthpiece may define an aerosol pathway from the heater to the aerosol outlet. The aerosol pathway may be substantially straight. The mouthpiece may define an aerosol pathway which passes directly from heating element to the aerosol outlet. The aerosol pathway may be substantially cylindrical. The aerosol pathway my be substantially symmetrical. The aerosol pathway may be aligned with a longitudinal axis of the system. The aerosol pathway may be aligned with a longitudinal axis of the cartridge. The aerosol pathway may be coaxial with a longitudinal axis of the system. The aerosol pathway may be coaxial with a longitudinal axis of the cartridge. The aerosol pathway may be arranged substantially centrally within the mouthpiece thickness. The aerosol pathway may be arranged substantially centrally within the mouthpiece width.

The heater may be arranged such that the heater width is substantially perpendicular to the mouthpiece housing length. The mouthpiece housing length may be measured along a longitudinal axis of the mouthpiece housing. The longitudinal axis of the mouthpiece housing may pass through the aerosol outlet. If the mouthpiece housing is provided as part of a cartridge in an aerosol-generating system, the longitudinal axis may pass from an aerosol outlet end of the mouthpiece housing to a connection end of the cartridge.

The heater may be arranged such that the heater width is substantially perpendicular to the mouthpiece housing thickness. The heater may be arranged such that the heater width is substantially aligned parallel to the mouthpiece housing width. As such, the heater may extend along the mouthpiece housing width.

The heater width dimension may be at least 20% greater than the heater thickness, i.e. the heater width dimension may be at least 120% of the heater thickness dimension. The heater width may be at least 20% greater than the heater thickness. The heater width may be at least 50% greater than the heater thickness. The heater width may be at least 100% greater than the heater thickness, i.e. the heater width dimension may be double the heater thickness dimension. The heater width may be at least three times the dimension of the heater thickness. The heater width may be at least four times the dimension of the heater thickness. The heater width may be at least five times the dimension of the heater thickness. The heater may be substantially elongate. The heater may substantially define a cuboid shape. The heater width may be substantially uniform along the heater length. The heater thickness may be substantially uniform along the heater length.

The heating element may be arranged on a heating surface of the porous body. The heater may be arranged such that the heating element is between the porous body and the aerosol outlet. The heater may be arranged such that the heating surface faces towards the aerosol outlet. Where the heater is provided in a cartridge, the heater may be arranged such that the heating element faces away from a connection end of the cartridge. When the cartridge is connected to a device, the heating element may be on a heating surface of the porous body which faces away from the device.

The heating element may be a heating track. The heating element may define a serpentine shape. The heating element may be a film heating element, such as a thick-film heating element. The heating element may comprise a metal or alloy.

The mouthpiece may comprise a mouthpiece insert defining the aerosol pathway. The mouthpiece housing may comprise an outer wall. The mouthpiece insert may be attached to the outer wall.

The mouthpiece outer wall may define an inner opening. The mouthpiece housing outer wall may be an annular or peripheral wall.

The mouthpiece housing may comprise a bracket. The mouthpiece housing may house a bracket. The mouthpiece housing may comprise an outer wall. The bracket may be configured to support the heater. The bracket may be configured to support the heater within the outer wall.

The mouthpiece housing may comprise a base. The mouthpiece housing may house at least one electrical connector, which may be provided on the base. The electrical connector may be configured to provide an electrical connection between the heating element and a power source. The electrical connector may be flexible, such that the electrical connector can flexibly connect to the heating element. The base may be configured to be fixedly attached to the bracket.

The heater may be disposed at or towards the connection end of the cartridge. The heater may be arranged substantially centrally within the mouthpiece housing width.

The mouthpiece housing may be substantially symmetrical. The mouthpiece housing may be substantially symmetrical about the longitudinal axis in at least one plane passing through the longitudinal axis. The mouthpiece insert may be substantially symmetrical. The mouthpiece insert may be substantially symmetrical about the longitudinal axis in at least one plane passing through the longitudinal axis. The aerosol pathway passing through the mouthpiece may be substantially symmetrical. The aerosol pathway passing through the mouthpiece may be substantially symmetrical about the longitudinal axis in at least one plane passing through the longitudinal axis.

Part of the mouthpiece insert which defines the aerosol pathway may be cylindrical. Part of the mouthpiece insert which defines the aerosol pathway may be tube-shaped. As such, the aerosol pathway passing through the mouthpiece may be cylindrical. Part of the mouthpiece insert which defines the aerosol pathway may be located centrally within the mouthpiece housing. Part of the mouthpiece insert which defines the aerosol pathway may be extend along the longitudinal axis of the system. Part of the mouthpiece insert which defines the aerosol pathway may have a longitudinal axis which is aligned with the longitudinal axis of the system. Part of the mouthpiece insert which defines the aerosol pathway may have a longitudinal axis which is coaxial with the longitudinal axis of the system.

A mouthpiece having a mouthpiece housing width which is greater than the mouthpiece thickness may be referred to as a “flat” mouthpiece.

The mouthpiece housing may be tapered. The mouthpiece housing may be tapered towards the aerosol outlet. The mouthpiece housing may be tapered such that the aerosol outlet end has a smaller area than an area of the connection end. The mouthpiece housing thickness may be tapered towards the aerosol outlet. As such, the mouthpiece housing thickness may be smaller at the aerosol outlet than at a distance away from the aerosol outlet. The mouthpiece housing may be tapered from a greater thickness at the connection end to a smaller thickness at the aerosol outlet end. The mouthpiece housing width may be tapered towards the aerosol outlet. The mouthpiece housing may be tapered from a greater width at the connection end to a smaller width at the aerosol outlet end. The mouthpiece housing width may be tapered gradually from a distal end of the mouthpiece housing to a proximal end of the mouthpiece housing.

The taper of the mouthpiece housing thickness may be at a steeper gradient than the taper of the mouthpiece housing width.

The cartridge may be configured for attachment to a device such that the air inlet is defined between the cartridge and the device. The cartridge may be configured for attachment to a device such that at least two air inlets are defined between the cartridge and the device, each inlet being provided between the cartridge and the device. The cartridge may be configured for attachment to a device such that at least two air inlets are defined between the cartridge and the device, at least two of the air inlets being separated from each other by the width of the cartridge.

There may be provided an aerosol-generating system. The aerosol-generating system may comprise: the aerosol-generating cartridge; and an aerosol-generating device configured to provide electrical power to the heater of the aerosol-generating cartridge.

The aerosol-generating system may comprise at least two air inlets. The or each air inlet may be provided between the cartridge and the device. The or each air inlet may be provided at an interface between the cartridge and the device housing. The at least two air inlets may be separated from each other by the width of the cartridge.

The system may comprise a power supply, which may be referred to as a power source. The mouthpiece and heater may be provided in a cartridge which is removably attachable to the power supply. The power supply may be provided in a device housing. The cartridge may be configured for attachment to the power supply such that the air inlet is defined between the cartridge and the power supply. The system may comprise control circuitry. The mouthpiece and heater may be provided in a cartridge which is removably attachable to the control circuitry. The control circuitry may be provided in a device housing. The system may comprise a power supply and a power supply housing, wherein the power supply housing is fixedly attached to the mouthpiece housing.

The porous body may be for wicking the liquid aerosol-forming substrate to the heating element. The porous body may have any suitable length. As noted above, as used herein, the term “length” is used to describe the maximum dimension of the porous body in the longitudinal direction of the system. That is, the maximum dimension of the porous body in the direction between the heating surface and the liquid absorption surface of the porous body, along the longitudinal axis of the system.

The porous body may have a length of greater than or equal to 0.5 millimetres. For example, the porous body may have a length of greater than or equal to 1 millimetre, greater than or equal to 2 millimetres, greater than or equal to 3 millimetres, greater than or equal to 4 millimetres, or greater than or equal to 5 millimetres.

The porous body may have a length of less than or equal to 20 millimetres. For example, the porous body may have a length of less than or equal to 10 millimetres, less than or equal to 9 millimetres, less than or equal to 8 millimetres, less than or equal to 7 millimetres, or less than or equal to 6 millimetres.

The porous body may have a length of between 0.5 millimetres and 20 millimetres. For example, the porous body may have a length of between 0.5 millimetres and 10 millimetres, between 0.5 millimetres and 9 millimetres, between 0.5 millimetres and 8 millimetres, between 0.5 millimetres and 7 millimetres, or between 0.5 millimetres and 6 millimetres.

The porous body may have a length of between 1 millimetre and 20 millimetres. For example, the porous body may have a length of between 1 millimetre and 10 millimetres, between 1 millimetre and 9 millimetres, between 1 millimetre and 8 millimetres, between 1 millimetre and 7 millimetres, or between 01 millimetre and 6 millimetres.

The porous body may have a length of between 2 millimetres and 20 millimetres. For example, the porous body may have a length of between 2 millimetres and 10 millimetres, between 2 millimetres and 9 millimetres, between 2 millimetres and 8 millimetres, between 2 millimetres and 7 millimetres, or between 2 millimetres and 6 millimetres.

The porous body may have a length of between 3 millimetres and 20 millimetres. For example, the porous body may have a length of between 3 millimetres and 10 millimetres, between 3 millimetres and 9 millimetres, between 3 millimetres and 8 millimetres, between 3 millimetres and 7 millimetres, or between 3 millimetres and 6 millimetres.

The porous body may have a length of between 4 millimetres and 20 millimetres. For example, the porous body may have a length of between 4 millimetres and 10 millimetres, between 4 millimetres and 9 millimetres, between 4 millimetres and 8 millimetres, between 4 millimetres and 7 millimetres, or between 4 millimetres and 6 millimetres.

The porous body may have a length of between 5 millimetres and 20 millimetres. For example, the porous body may have a length of between 5 millimetres and 10 millimetres, between 5 millimetres and 9 millimetres, between 5 millimetres and 8 millimetres, between 5 millimetres and 7 millimetres, or between 5 millimetres and 6 millimetres. For example, the porous body may have a length of 5 millimetres.

The porous body may have any suitable cross-sectional shape. For example, the cross-sectional shape of the porous body may be circular, semi-circular, elliptical, triangular, square, rectangular or trapezoidal.

The cross-section of the porous body may be substantially constant along the length of the porous body. The surface area of the liquid absorption surface of the porous body may be substantially the same as the surface area of the heating surface of the porous body.

The cross-section of the porous body may vary along the length of the porous body. The surface area of the liquid absorption surface of the porous body may be different to the surface area of the heating surface of the porous body. The surface area of the liquid absorption surface of the porous body may be greater than the surface area of the heating surface of the porous body.

The porous body may be substantially incompressible. The porous body may comprise any suitable material. The porous body may comprise a heat resistant material. The porous body may comprise a material that does not chemically interact with the liquid aerosol-generating substrate. The porous body may be a porous ceramic body. As used herein, the term “porous ceramic body” is used to describe a porous body comprising a ceramic. The porous ceramic body may comprise a sintered ceramic. The porous ceramic body may comprise any suitable ceramic.

The porous ceramic body may comprise one or more of a ceramic carbide, a ceramic nitride, a ceramic oxide, and a ceramic silicate. Examples of suitable ceramics include, but are not limited to, aluminium oxides, aluminosilicates, calcium phosphates, calcium silicates, silicon carbides, silicon nitrides, silicon oxides, and zirconium oxides. The porous ceramic body may comprise one or more of alumina (Al₂O₃), an aluminosilicate, a boride, silica (SiO₂), a silicide, silicon carbide, silicon nitride, and zirconia (ZrO₂). The porous ceramic body may comprise one or more of alumina (Al₂O₃), silica (SiO₂), and zirconia (ZrO₂). The porous ceramic body may comprise silica (SiO₂). The porous ceramic body may comprise silica (SiO₂) and alumina (Al₂O₃). The porous ceramic body may comprise silica (SiO₂), alumina (Al₂O₃) and calcium oxide (CaO).

The cartridge may comprise a cartridge housing. The cartridge housing may be formed from any suitable material or combination of materials. Suitable materials include, but are not limited to, fluorinated ethylene propylene (FEP), polyether ether ketone (PEEK), polyethylene (PE), high-density polyethylene (HDPE), polyethylene terephthalate (PET), polyoxymethylene (POM), polypropylene (PP), polytetrafluoroethylene (PTFE), and copolymers such as Tritan™, which is made from three monomers: dimethyl terephthalate (DMT), cyclohexanedimethanol (CHDM), and 2,2,4,4-tetramethyl-1,3-cyclobutanediol (CBDO). The cartridge housing may be formed from a durable material. The cartridge housing may be formed from a liquid impermeable material. The cartridge housing may be formed form a mouldable plastic material.

The cartridge housing may be formed by any suitable method. Suitable methods include, but are not limited to, blistering, blow forming, extrusion, deep drawing, and injection moulding. The cartridge may comprise a mouthpiece. The cartridge may comprise a connection end at the distal end of the cartridge. The connection end may be configured to couple the cartridge to an aerosol-generating device.

The cartridge may comprise one or more air inlets through which, in use, air may be drawn into the cartridge. The cartridge may comprise one or more aerosol outlets through which, in use, aerosol may be drawn out of the cartridge. The cartridge may comprise an aerosol outlet at the proximal end of the cartridge. Where the cartridge comprises a mouthpiece, the mouthpiece may comprise one or more aerosol outlets through which, in use, aerosol may be drawn out of the mouthpiece. The one or more aerosol outlets may be provided in the mouthpiece housing. The one or more air inlets may be in fluid communication with the one or more aerosol outlets to define an airflow pathway through the cartridge. The cartridge may comprise an enclosed airflow pathway extending from the one or more air inlets to the one or more aerosol outlets. The enclosed airflow pathway may extend from the one or more air inlets, past the heater, to the one or more aerosol outlets. The enclosed airflow pathway may pass around an external surface of the liquid storage portion. The enclosed airflow pathway may pass through the liquid storage portion. For example, the liquid storage portion may have an annular cross-section defining an internal passage, and the enclosed airflow pathway may extend through the internal passage. The internal pathway may extend from a proximal end of the mouthpiece housing towards a distal end of the mouthpiece housing. The internal passage may extend only part of the way from the proximal end of the mouthpiece housing towards the distal end of the mouthpiece housing.

The cartridge may comprise a first airflow pathway that extends from the one or more air inlets towards the resistive heater in a first direction. The cartridge may comprise a second airflow pathway that extends past the resistive heating element. The cartridge may comprise a third airflow pathway that extends from the resistive heater to the one or more aerosol outlets in a second direction. The second airflow pathway may provide a fluid connection between the first airflow pathway and the third airflow pathway. The third airflow pathway may be an aerosol pathway. The cartridge may be configured such that air flow past the heater entrains vaporised aerosol-generating substrate.

The cartridge housing of the cartridge may define the liquid storage portion. The cartridge housing may be the mouthpiece housing. The cartridge housing and the liquid storage portion may be integrally formed. The liquid storage portion may be formed separately from the cartridge housing and arranged within the cartridge housing. The liquid storage portion may be located proximate to a liquid absorption surface of the porous body of the heater. The liquid storage portion may be referred to as a reservoir. The liquid storage portion may be symmetric.

The liquid storage portion may contain a liquid aerosol-generating substrate. The aerosol-generating substrate may comprise a therapeutic composition, or a composition for medical treatment. The aerosol-generating substrate may comprise cannabis.

The liquid aerosol-generating substrate may comprise nicotine. As used herein, the term “nicotine” is used to describe nicotine, a nicotine base or a nicotine salt. The liquid aerosol-generating substrate may comprise natural nicotine. The liquid aerosol-generating substrate may comprise synthetic nicotine. The liquid aerosol-generating substrate may comprise an aerosol former. The liquid aerosol-generating substrate may comprise nicotine and an aerosol former. The aerosol former may be any suitable known compound or mixture of compounds that, in use, facilitates formation of a dense and stable aerosol. The aerosol former may be substantially resistant to thermal degradation at temperatures typically reached during use of an aerosol-generating system comprising the cartridge. Examples of suitable aerosol formers include, but are not limited to: polyhydric alcohols such as, for example, triethylene glycol, 1,3-butanediol, propylene glycol and glycerine; esters of polyhydric alcohols such as, for example, glycerol mono-, di- or triacetate; aliphatic esters of mono-, di- or polycarboxylic acids such as, for example, dimethyl dodecanedioate and dimethyl tetradecanedioate; and combinations thereof. Advantageously, the aerosol former may comprise one or more polyhydric alcohols. More advantageously, the aerosol former comprises one or more polyhydric alcohols selected from the group consisting of propylene glycol, triethylene glycol, 1,3-butanediol and glycerine.

The aerosol former may comprise one or both of glycerine and propylene glycol. The aerosol former may consist of glycerine. The aerosol former may consist of propylene glycol. The aerosol former may consist of a combination of glycerine and propylene glycol. The liquid aerosol-generating substrate may comprise water. The liquid aerosol-generating substrate may comprise one or more flavourants. The liquid aerosol-generating substrate may comprise one or more natural flavourants. The liquid aerosol-generating substrate may comprise one or more synthetic flavourants.

The liquid aerosol-generating substrate may have a nicotine content of greater than or equal to 0.5 percent by weight, greater than or equal to 1 percent by weight, or greater than or equal to 1.5 percent by weight. The liquid aerosol-generating substrate may have a nicotine content of less than or equal to 10 percent by weight, less than or equal to 5 percent by weight, or less than or equal to 3 percent by weight. The liquid aerosol-generating substrate may have a nicotine content of between 0.5 percent by weight and 10 percent by weight. For example, the liquid aerosol-generating substrate may have a nicotine content of between 0.5 percent by weight and 5 percent by weight or between 0.5 percent by weight and 3 percent by weight. The liquid aerosol-generating substrate may have a nicotine content of between 1 percent by weight and 10 percent by weight. For example, the liquid aerosol-generating substrate may have a nicotine content of between 1 percent by weight and 5 percent by weight or between 1 percent by weight and 3 percent by weight. The liquid aerosol-generating substrate may have a nicotine content of between 1.5 percent by weight and 10 percent by weight. For example, the liquid aerosol-generating substrate may have a nicotine content of between 1.5 percent by weight and 5 percent by weight or between 1.5 percent by weight and 3 percent by weight. For example, the liquid aerosol-generating substrate may have a nicotine content of 2 percent by weight.

The cartridge may be designed to be disposed of once the liquid aerosol-generating substrate contained in the liquid storage portion is depleted. The cartridge may be designed to be refillable.

The aerosol-generating device may comprise a device housing. The device housing may be formed from any suitable material or combination of materials. Suitable materials include, but are not limited to, alloys, metals, and plastics such as, for example, polyether ether ketone (PEEK), polyethylene (PE), high density polyethylene (HDPE), and polypropylene (PP). The device housing may define a cavity for receiving at least a portion of the cartridge.

The aerosol-generating device may have a connection end configured to removably connect the aerosol-generating device to the cartridge.

The device may comprise a power supply. The power supply may be any suitable power supply. The power supply may be a DC power supply. The power supply may be a battery. The power supply may be a lithium based battery. For example, the power supply may be a lithium-ion battery, such as a lithium cobalt oxide (CBO) battery, a lithium iron phosphate (LFP) battery, or a lithium-titanate (LTO) battery, or a lithium-polymer battery. The power supply may be a nickel based battery. For example, the battery may be a nickel-metal hydride battery (Ni-MH) or a nickel-cadmium (Ni—Cd) battery. The power supply may be another form of charge storage device such as a capacitor. The power supply may be rechargeable. The power supply may be configured for many cycles of charge and discharge. The power supply may have a capacity that allows for the storage of enough energy for one or more user experiences of the aerosol-generating system. For example, the power supply may have sufficient capacity to allow for the continuous generation of aerosol for a period of around six minutes, corresponding to the typical time taken to smoke a conventional cigarette, or for a period that is a multiple of six minutes. The power supply may have sufficient capacity to allow for a predetermined number of puffs or discrete activations of the aerosol-generating system.

The aerosol-generating device may comprise an electrical connector configured to connect the aerosol-generating device to an electrical connector of an external power supply, for charging the power supply of the aerosol-generating device.

The aerosol-generating device may comprise control circuitry. The control circuitry may be configured to supply power to the resistive heating element continuously following activation of the aerosol-generating device. The control circuitry may be configured to supply power to the resistive heating element intermittently following activation of the aerosol-generating device, such as on a puff-by-puff basis. The power may be supplied to the resistive heating element in the form of pulses of electrical current, for example, by means of pulse width modulation (PWM).

The control circuitry may comprise any suitable electronic components. The control circuitry may comprise a memory. The control circuitry may comprise a microprocessor. The microprocessor may be a programmable microprocessor, a microcontroller, or an application specific integrated chip (ASIC) or other electronic circuitry capable of providing control.

The control circuitry may comprise other electronic components. For example, the control circuitry may comprise one or more of sensors, switches, and display elements.

The aerosol-generating system may comprise a puff detector. The puff detector may be configured to detect when a user draws on the aerosol-generating system. The puff detector may be any suitable sensor that is capable of detecting when a user draws on the aerosol-generating device. For example, the puff detector may be an airflow sensor. The control circuitry may be configured to supply power to the resistive heating element when the puff detector detects a user drawing on the aerosol-generating system.

The invention is defined in the claims. However, below there is provided a non-exhaustive list of non-limiting examples. Any one or more of the features of these examples may be combined with any one or more features of another example, embodiment, or aspect described herein.

Example Ex 1. An aerosol-generating cartridge comprising:
an aerosol outlet end, a connection end, and a longitudinal direction extending between the aerosol outlet end and the connection end;
a mouthpiece comprising a mouthpiece housing having a mouthpiece housing length in the longitudinal direction, a mouthpiece housing width and a mouthpiece housing thickness, the mouthpiece housing width being greater than the mouthpiece housing thickness;
a heater arranged in the mouthpiece housing, the heater comprising:
   a heating element for vaporising a liquid aerosol-forming substrate; and
   a porous body for conveying the liquid aerosol-forming substrate to the heating element, the porous body having a heating surface facing the air outlet, the heating element being located on the heating surface of the porous body,
an aerosol outlet at the aerosol outlet end, and an air inlet between the aerosol outlet end and the connection end; the air inlet being in fluid communication with the aerosol outlet to define an airflow pathway through the mouthpiece housing, the airflow pathway extending from the heating element to the aerosol outlet in the longitudinal direction of the cartridge,
wherein the heater has a heater length in the longitudinal direction, a heater width and a heater thickness, the heater width being greater than the heater thickness, and the heater is oriented such that the heater width extends in substantially the same direction as the mouthpiece housing width.

Example Ex 2. The aerosol-generating cartridge according to Ex 1, wherein the cartridge defines an aerosol generation chamber adjacent to the heating element, and the airflow pathway is configured to approach the aerosol generation chamber in a width direction or thickness direction of the mouthpiece.

Example Ex 3. The aerosol-generating cartridge according to Ex 1 or Ex 2, wherein the air inlet is disposed at a longitudinal position between the longitudinal positions of the heater and the aerosol outlet.

Example Ex 4. The aerosol-generating cartridge according to any of the preceding Examples, wherein the air inlet is disposed at a longitudinal position between the longitudinal positions of the heating element and the aerosol outlet.

Example Ex 5. The aerosol-generating cartridge according to any of the preceding Examples, wherein the mouthpiece defines an aerosol pathway from the heater to the aerosol outlet, the aerosol pathway being substantially straight.

Example Ex 6. The aerosol-generating cartridge according to any of the preceding Examples, wherein the mouthpiece defines an aerosol pathway which passes directly from heating element to the aerosol outlet.

Example Ex 7. The aerosol-generating cartridge according to any of the preceding Examples, wherein the mouthpiece comprises: a mouthpiece insert defining the aerosol pathway; and the mouthpiece housing comprises an outer wall, the mouthpiece insert being attached to the outer wall.

Example Ex 8. The aerosol-generating cartridge according to any of the preceding Examples, wherein the heater is arranged such that the heater width is substantially perpendicular to the mouthpiece housing length.

Example Ex 9. The aerosol-generating cartridge according to any of the preceding Examples, wherein the heater is arranged such that the heater width is substantially perpendicular to the mouthpiece housing thickness.

Example Ex 10. The aerosol-generating cartridge according to any of the preceding Examples, wherein the heater is arranged such that the heater width is substantially aligned parallel to the mouthpiece housing width.

Example Ex 11. The aerosol-generating cartridge according to any of the preceding Examples, wherein the porous body comprises a porous ceramic.

Example Ex 12. The aerosol-generating cartridge according to any of the preceding Examples, wherein the mouthpiece housing comprises a bracket and an outer wall, the bracket being configured to support the heater within the outer wall.

Example Ex 13. The aerosol-generating cartridge according to any of the preceding Examples, wherein the mouthpiece housing comprises a base having at least one electrical connector, the electrical connector being configured to provide an electrical connection between the heating element and a power source.

Example Ex 14. The aerosol-generating cartridge according to any of the preceding Examples, wherein the heater is disposed at or towards the connection end of the cartridge.

Example Ex 15. The aerosol-generating cartridge of any of the preceding Examples, wherein the heater is arranged substantially centrally within the mouthpiece housing width.

Example Ex 16. The aerosol-generating cartridge according to any of the preceding Examples, wherein the mouthpiece housing is tapered such that the aerosol outlet end has a smaller area than an area of the connection end.

Example Ex 17. The aerosol-generating cartridge according to any of the preceding Examples, wherein the mouthpiece housing is tapered from a greater thickness at the connection end to a smaller thickness at the aerosol outlet end.

Example Ex 18. The aerosol-generating cartridge according to any of the preceding Examples, wherein the mouthpiece housing is tapered from a greater width at the connection end to a smaller width at the aerosol outlet end.

Example Ex 19. The aerosol-generating cartridge according to any of the preceding Examples, wherein the cartridge is configured for attachment to a device such that the air inlet is defined between the cartridge and the device.

Example Ex 20. An aerosol-generating system comprising:
the aerosol-generating cartridge of any of the preceding Examples; and
an aerosol-generating device configured to provide electrical power to the heater of the aerosol-generating cartridge.

Example Ex 21. The aerosol-generating system according to Example Ex 20, comprising at least two air inlets, each provided between the cartridge and the device.

Example Ex 22. The aerosol-generating system according to Example Ex 21, wherein the at least two air inlets are provided between the cartridge and the device, and separated from each other by the width of the cartridge.

The invention will now be further described, by way of example only, with reference to the accompanying drawings in which:

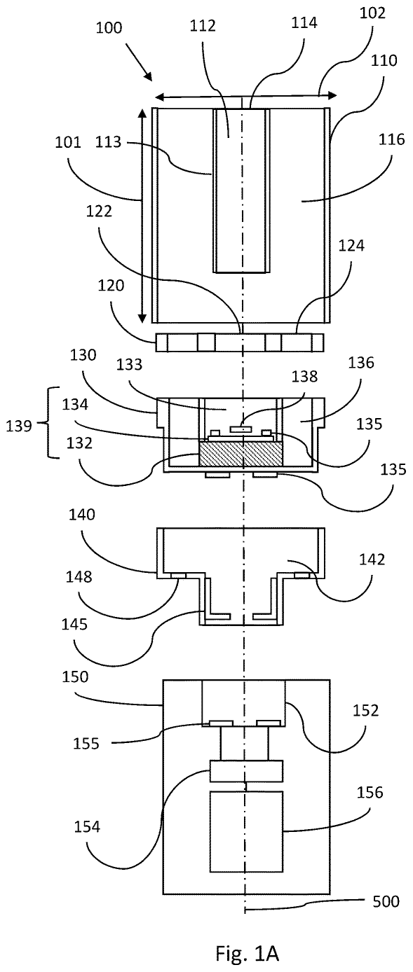

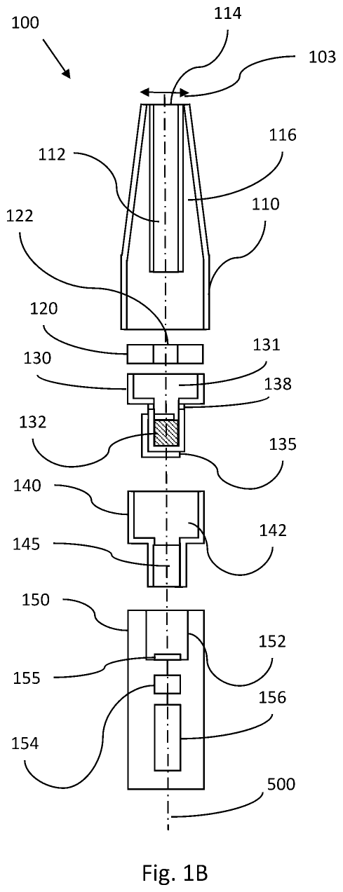

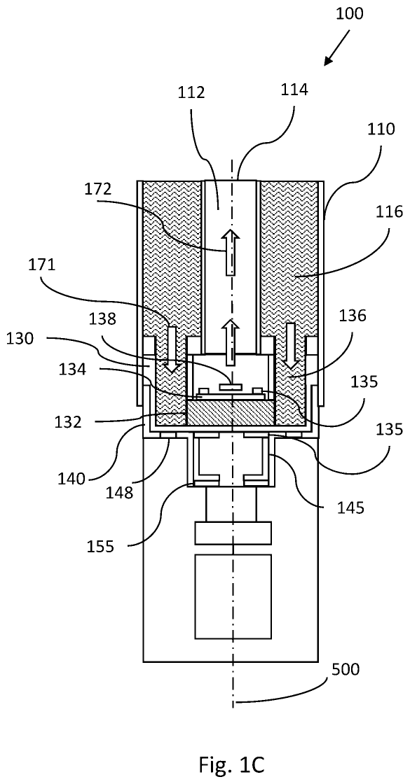

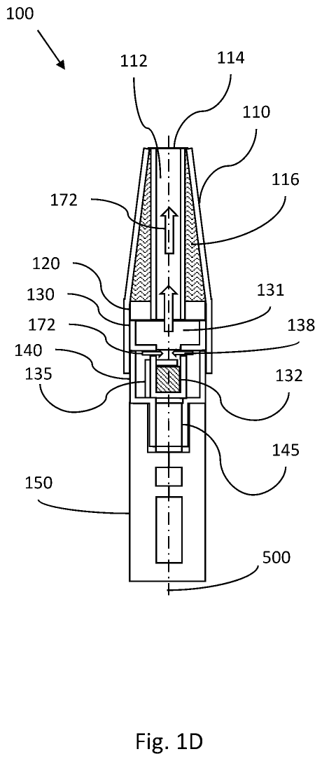

FIG. 1A shows a schematic cross-section through the components of a disassembled embodiment of a system;

FIG. 1B shows a schematic cross-section through the system of FIG. 1A, taken perpendicularly to the cross-section of FIG. 1A;

FIG. 1C shows a schematic cross-section through an assembled embodiment of a system;

FIG. 1D shows a schematic cross-section through the system of FIG. 1C, taken perpendicularly to the cross-section of FIG. 1C;

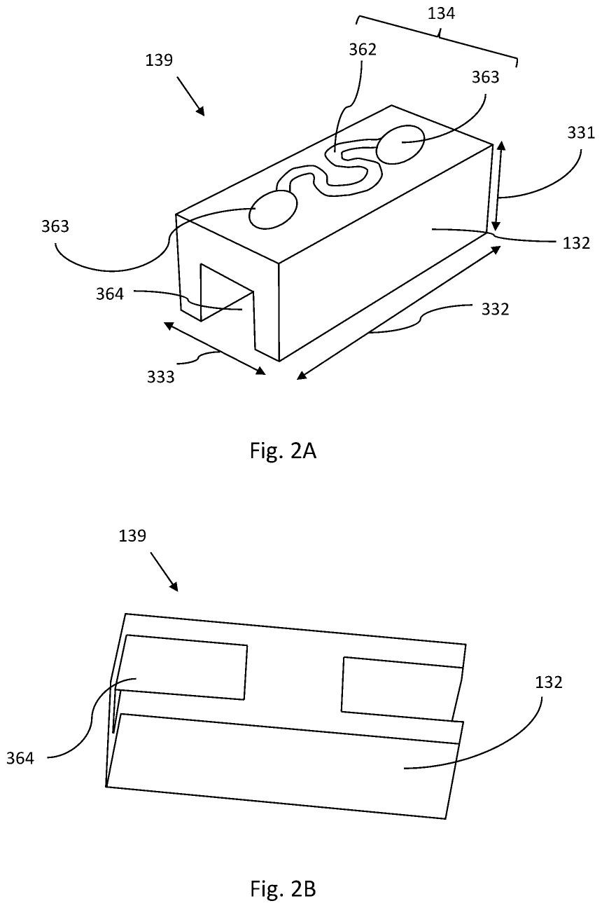

FIG. 2A shows a schematic perspective view of a heater of the system; and

FIG. 2B shows a schematic alternative perspective view of the heater of FIG. 2A.

It will be appreciated that FIGS. 1A to 2B are schematic and have been simplified for the purposes of clarity. Consequently, some features may have been omitted and the features shown are not necessarily drawn to scale.

References to orientations such as proximal and distal, etc. when describing features shown in the figures are not intended to imply any limitation on the orientation of those features but are merely intended to show the relative spatial arrangement of the features. It will be appreciated that the features may have different orientations in use.

FIG. 1A shows a schematic cross-section through the components of a disassembled aerosol-generating system 100. The aerosol-generating system 100 comprises a mouthpiece housing 110, a reservoir sealing element 120, a bracket 130, a base 140, and a device body 150.

The mouthpiece housing 110, reservoir sealing element 120, bracket 130 and base 140 may be assembled together to form a cartridge. The cartridge may be reversibly couplable to the device body 150 via the base 140 to form the aerosol-generating system.

Alternatively, the system 100 may be provided as a singular aerosol-generating device comprising all of the mouthpiece housing 110, reservoir sealing element 120, bracket 130, base 140 and device body 150 assembled together, such that the base 140 is not reversibly couplable to the device body 150.

The mouthpiece housing 110 comprises an outer wall and an insert 113. The outer wall is formed from a polymer, such as polycyclohexylenedimethylene terephthalate glycol (PCTG). The outer wall is a peripheral, annular outer wall. The outer wall of the mouthpiece housing 110 partially defines a reservoir 116 configured to contain liquid aerosol-forming substrate. The insert 113 defines an airflow passage 112 located within the reservoir 116. The airflow passage 112 extends from a proximal end of the mouthpiece housing 110 towards a distal end of the mouthpiece housing 110. The airflow passage 112 extends only part of the way from the proximal end of the mouthpiece housing 110 to the distal end of the mouthpiece housing 110. The insert 113 defining the airflow passage 112 is also formed from a polymer or a copolymer, such as polycyclohexylenedimethylene terephthalate glycol (PCTG). The airflow passage 112 is configured to direct fluid to the aerosol outlet 114. The aerosol outlet 114 is defined at a proximal end of the airflow passage 112 and the proximal end of the mouthpiece housing 110.

The aerosol-generating system has a longitudinal axis 500. The mouthpiece housing 110 has a width and a thickness, both perpendicular to the longitudinal axis 500. In FIG. 1A, the mouthpiece housing width is within the plane of the page, and the thickness is normal to the page. As is illustrated in FIGS. 1A and 1B, the mouthpiece housing width is greater than the mouthpiece housing thickness. In the embodiment shown in FIG. 1A, the mouthpiece housing 110 has a uniform width along its length. However, it will be appreciated that the mouthpiece housing 110 may have a varying width, for example having a tapered shape. In such an embodiment, the mouthpiece housing width at the proximal end 118 of the mouthpiece housing 110 is smaller than the mouthpiece housing width at the distal end 119 of the mouthpiece housing 110.

The insert defining the airflow passage 112 is positioned substantially centrally within the mouthpiece housing 110 in relation to the width and the thickness of the mouthpiece housing 110.

The reservoir sealing element 120 is configured to be located within the outer wall of the mouthpiece housing 110. In particular, the reservoir sealing element 120 is configured form a liquid-tight seal with an inner surface of the outer wall of the mouthpiece housing 110, such that the reservoir 116 is defined. The reservoir sealing element 120 comprises a silicone body. The reservoir sealing element 120 further comprises an airflow passage aperture 122. The airflow passage aperture 122 extends from a first side of the reservoir sealing element 120 to a second side of the reservoir sealing element 120. The airflow passage aperture 122 is configured to receive the insert 113 when the reservoir sealing element 120 is located within the outer wall of the mouthpiece housing 110, such that at least a portion of the insert 113 is located within the airflow passage aperture 122 when the reservoir sealing element 120 is located within the outer wall of the mouthpiece housing 110.

The reservoir sealing element 120 further comprises two substrate channel apertures 124. Each substrate channel aperture 124 extends from the first side of the reservoir sealing element 120 to the second side of the reservoir sealing element 120. The airflow passage aperture 122 is located substantially between the two substrate channel apertures 124. The two substrate channel apertures 124 are substantially identical.

The bracket 130 comprises a bracket body formed from a polymer, such as polycyclohexylenedimethylene terephthalate glycol (PCTG).

The bracket 130 is configured to support a heater 139. The heater 139 comprises a porous body 132 and a heating element in the form of a heater track 134. The porous body 132 may be a porous ceramic body. The heater track 134 is arranged on a heating surface of the porous body 132. The heater 139 is arranged such that the heater track 134 faces in a direction towards the aerosol outlet 114. The heater 139 is arranged so that the heater track faces away from the device body 150.

The heater 139 is illustrated in more detail in FIGS. 2A and 2B. The heater 139 has a length 331, a width 332, and a thickness 333. In the heater illustrated in FIGS. 2A and 2B, the heater width 332 is greater than the heater length 331. In the heater illustrated in FIGS. 2A and 2B, the heater width 332 is greater than the heater thickness 333.

The porous body 132 substantially defines the shape of the heater 139. The porous body 132 is substantially elongate, such that the porous body 132 has a width greater than the porous body length and greater than the porous body thickness. The heater 139 is located within a heater cavity within the bracket 130. The heater 139 is arranged such that the width 332 of the porous body 132 is substantially parallel to the mouthpiece housing width 102. The heater 139 is arranged such that the thickness of the porous body 132 is substantially parallel to the mouthpiece housing thickness 103.

The heater 139 further comprises a silicone sealing cover (not shown) to partially surround the heater 139 and to form a liquid-tight seal with the bracket 130 when the heater 139 is located within the heater cavity.

The bracket 130 further comprises two bracket fluid channels 136. Each bracket fluid channel 136 extends from a proximal surface of the bracket to a respective opposing end of the heater cavity. When the heater 139 is located within the heater cavity, each bracket fluid channel 136 extends from the proximal surface of the bracket to a respective opposing end of the porous body 132 of the heater 139.

The bracket 130 further comprises an aerosol generation chamber 133. The aerosol generation chamber 133 is defined by an opening in the proximal surface of the bracket, and side walls separating the aerosol generation chamber 133 from both bracket fluid channels 136. The aerosol generation chamber 133 is located adjacent to the heater cavity. When the heater 139 is located within the heater cavity, the heater track 134 is positioned facing and adjacent to the aerosol generation chamber 133. The aerosol generation chamber 133 further comprises two bracket air inlets 138. The two bracket air inlets 138 are positioned on opposite sides of the aerosol generation chamber 133 to each other. The two bracket air inlets 138 extend through from the aerosol generation chamber 133 to an outer surface of the bracket 130.

The bracket 130 further comprises two bracket electrical contacts 135. The two bracket electrical contacts 135 each contact opposite ends of the heater track 134. The two bracket electrical contacts 135 then extend through apertures in the bracket 130 to the outer surface of the bracket 130. The two bracket electrical contacts 135 extend to a distal surface of the bracket 130, the distal surface of the bracket 130 being opposite to the proximal surface of the bracket 130. The two bracket electrical contacts 135 comprise copper with a gold coating.

The base 140 comprises a base body formed from a polymer, for example polycyclohexylenedimethylene terephthalate glycol (PCTG).

The base 140 further comprises a base cavity 142. The base cavity 142 is defined by the base body and a base cavity aperture on a proximal surface of the base 140. The base cavity 142 is configured to receive a portion of the bracket 130 when the base 140 is coupled to the bracket 130. The base 140 is configured to be coupled to the bracket 130 by a snap-fit connection.

The base body comprises an outer base wall extending from the proximal surface of the base 140 to a distal surface of the base. Two base air inlets 148 are defined in the outer base wall, and extend through the outer base wall to the base cavity 142. The base air inlets 148 are defined on opposite sides of the base 140 to each other.

The base 140 further comprises an electrical connector 145. The electrical connector is configured for attachment to the base body. The electrical connector 145 is configured to be accessible from a distal surface of the base 140. The electrical connector 145 comprises two arms. Each arm is configured to contact a corresponding bracket electrical contact 135 when the portion of the bracket 130 is received in the base cavity 142. The arms of the electrical connector 145 may comprise a metal or alloy, such as stainless steel 304H with a gold coating.

The device body 150 comprises a device cavity 152. The device cavity 152 is defined by the device body 150 and a device cavity aperture on a proximal surface of the device body 150. The device cavity 152 is configured to receive a portion of the base 140 when the base 140 is coupled to the device body 150. The base 140 is configured to be reversibly coupled to the device body 150 by a snap-fit connection.

A shoulder is defined in the outer base wall of the base 140, which corresponds to a shoulder defined on the device body 150. The two base air inlets 148 are located on the shoulder defined in the outer base wall.

The device body 150 further comprises two device electrical contacts 155 located on a distal surface of the device cavity 152. The device electrical contacts 155 are configured to contact the electrical connector 145 when the base 140 is coupled to the device body 150. The device body 150 further comprises control circuitry 154. The device electrical contacts 155 are connected to the control circuitry 154, which may comprise a processor, via electrical wires. The device body 150 further comprises a battery 156. The battery 156 may comprise a rechargeable lithium ion battery, that is rechargeable via an electrical connector (not shown) configured to be connected at a distal end of the device body 150. The battery 156 is connected to the control circuitry 154 via electrical wires. The two device electrical contacts 155 may comprise a metal or alloy, such as stainless steel 304H with a gold coating.

FIG. 1B shows a schematic cross-section through the disassembled system 100, but from a side view perpendicular to the front view. The system 100 in FIG. 1B is otherwise identical to that described with respect to FIG. 1A.

It can be seen in FIG. 1B, with comparison to FIG. 1A that the mouthpiece housing width 102 is greater than the mouthpiece housing thickness 103. It can also be seen in FIG. 1A that the mouthpiece housing length 101 is greater than the mouthpiece housing width 102. FIG. 1B also shows that the mouthpiece housing 110 is tapered, such that the thickness of the mouthpiece body decreases from the distal end towards the proximal end of the mouthpiece housing 110. Because of this taper, it can be seen that a cross sectional area of the mouthpiece housing 110 perpendicular to the longitudinal axis 500 is smaller at the proximal end of the mouthpiece housing 110 than at the distal end of the mouthpiece housing 110.

FIG. 1C shows a schematic cross-section through an assembled embodiment of a system. The system 100 in FIG. 1C is otherwise identical to that described with respect to FIGS. 1A and 1B.

In FIG. 1C, the reservoir sealing element 120 is located within the outer wall of the mouthpiece housing 110 such that a liquid-tight seal with an inner surface of the outer wall of the mouthpiece housing 110 is formed. The insert 113 is received within the airflow passage aperture 122 such that at least a portion of the insert 113 is located within the airflow passage aperture 122. A further a fluid-tight seal between insert 113 and the reservoir sealing element is therefore formed.

The bracket 130 is partially located within the mouthpiece housing 110, such that the proximal surface of the bracket 130 contacts the reservoir sealing element 120 to form a liquid-tight seal with the reservoir sealing element 120. Each of the two substrate channel apertures 124 of the reservoir sealing element 120 is aligned with a corresponding bracket fluid channel 136 of the bracket 130. The bracket fluid channels 136, substrate channel apertures 124, and mouthpiece housing 110 therefore define outer surfaces of the reservoir 116. The reservoir 116 is shown in FIG. 1C filled with liquid aerosol-forming substrate.

In FIG. 1C, the base 140 is coupled to the bracket 130 by a snap-fit connection. A portion of the bracket 130 is received in the base cavity 142. The bracket electrical contacts 135 are in contact with the electrical connector 145. The base 140 is further coupled to the mouthpiece housing 110 by a snap-fit connection. The base is coupled to the mouthpiece housing 110 such that the bracket 130 and reservoir sealing element 120 are held securely in place within the mouthpiece housing 110.

The mouthpiece housing 110, reservoir sealing element 120, bracket 130 and base 140 together form the cartridge of the system 100.

The cartridge comprises a cartridge airflow pathway. The cartridge airflow pathway extends from the base air inlets 148 to the bracket air inlets 138 via space between the base 140 and the bracket 130, and from the bracket air inlets 138 through the aerosol-generation chamber 133 and airflow passage 112 to the aerosol outlet 114.

As shown in FIG. 1C, the cartridge can be coupled to the device body 150. In use, the user may reversibly couple the cartridge to the device body and decouple the cartridge from the device body 150, for example when the reservoir 116 is empty of liquid aerosol-forming substrate.

When the base 140 of the cartridge is coupled to the device body 150, a small gap is present between the base 140 and the device body 150, such that air may enter the base air inlets 148.

When coupled to the device body 150, a portion of the base 140 is received within the device cavity 152, such that the device electrical contacts 155 are in contact with the electrical connector 145. A complete electrical pathway is therefore formed from the device electrical contacts 155 to the electrical connector 145, to the bracket electrical contacts 135 and then to the heater track 134.

In use, the user can connect the cartridge to the device body 150 and press a button (not shown) located on the side of the device body 150. The button is connected to the control circuitry 154. The control circuitry 154 is configured to control the supply of power from the battery 156 to the heater track 134 via the device electrical contacts 155, the base electrical contacts 145, and bracket electrical contacts 135. When the user presses the button, power is supplied from the battery to the heater track, such that the heater track increases in temperature. The liquid aerosol-forming substrate in the reservoir 116 is drawn down the bracket fluid channels 136 to the porous body 132 of the heater 139. The porous body 132 wicks the liquid aerosol-forming substrate to the heating surface of the porous body 132 where it is volatilised by the hot heater track 134. This transportation of liquid aerosol-forming substrate is illustrated with liquid aerosol-forming substrate transport arrows 171.

When the user inhales upon the mouthpiece housing 110, air is drawn through the cartridge airflow pathway. In particular, air is drawn into the base air inlets 148 and then to the bracket air inlets 138 via space between the base 140 and the bracket 130, and from the bracket air inlets 138 into the aerosol-generation chamber 133. Volatilised aerosol-forming substrate condenses within the flow of air through the aerosol-generation chamber 133, and is drawn into the mouth of the user via the airflow passage 112 and aerosol outlet 114. This flow of air is illustrated with airflow arrows 172 shown in FIGS. 1C and 1D.

FIG. 1D also shows a schematic cross-section through an assembled system 100, but from a side view perpendicular to the front view. The assembled system 100 in FIG. 1C is otherwise identical to that described with respect to FIG. 1C.

As illustrated in FIG. 1D, the flow of air 172 enters the aerosol-generation chamber 133 via bracket air inlets 138 approximately perpendicular to the longitudinal axis 500. The longitudinal axis 500 is substantially parallel to the direction of air flow from the aerosol-generation chamber 133, through the airflow passage 112 and to the aerosol outlet 114. The aerosol-generation chamber 133, the airflow passage 112 and to the mouthpiece airflow outlet 114 are aligned in a straight line such that the air flow pathway from the aerosol-generation chamber 133, through the airflow passage 112 and to the mouthpiece airflow outlet 114 is straight.

FIG. 2A shows a perspective view of a heater schematic and FIG. 2B shows an alternative perspective view of the heater schematic.

The heater track 134 is illustrated as arranged on the heating surface of the porous body 132. The heater track 134 comprises two heater track electrical contacts 363 at opposite ends of the heating surface of the porous body 132. The two heater track electrical contacts 363 are configured to contact the bracket electrical contacts 135, as described above.

The heater track further comprises a serpentine heater track pathway 362 extending between the two heater track electrical contacts 363. The serpentine heater track pathway 362 is configured to be resistively heated when a current is passed through the serpentine heater track pathway 362. The heater track 134 is a metallic track comprising a film of metal. The two heater track electrical contacts 363 are integrally formed with the serpentine heater track pathway 362.

Two liquid feed cut-outs 364 are defined in the porous body 132. Both of the two liquid feed cut-outs 364 are defined in distal surface of the porous body 132. The two liquid feed cut-outs are defined in opposite ends of the porous body 132. When the heater 139 is positioned in the bracket 130, the liquid aerosol-forming substrate flows from the bracket fluid channels 136 into the corresponding liquid feed cut-out 364, and subsequently into the porous body 132.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. An aerosol-generating cartridge, comprising:
an aerosol outlet end, a connection end, and a longitudinal direction extending between the aerosol outlet end and the connection end;
a mouthpiece comprising a mouthpiece housing having a mouthpiece housing length in the longitudinal direction, a mouthpiece housing width, and a mouthpiece housing thickness, the mouthpiece housing width being greater than the mouthpiece housing thickness;
a heater arranged in the mouthpiece housing, the heater comprising:
a heating element configured to vaporise a liquid aerosol-forming substrate, and
a porous body configured to convey the liquid aerosol-forming substrate to the heating element, the porous body having a heating surface facing the air outlet, the heating element being located on the heating surface of the porous body;
an aerosol outlet at the aerosol outlet end; and
an air inlet between the aerosol outlet end and the connection end, the air inlet being in fluid communication with the aerosol outlet to define an airflow pathway through the mouthpiece housing, the airflow pathway extending from the heating element to the aerosol outlet in the longitudinal direction of the cartridge,
wherein the heater has a heater length in the longitudinal direction, a heater width, and a heater thickness, the heater width being greater than the heater thickness, and the heater being oriented such that the heater width extends in substantially the same direction as the mouthpiece housing width,
wherein the cartridge defines an aerosol generation chamber adjacent to the heating element, and
wherein the airflow pathway is configured to approach the aerosol generation chamber in a width direction of the mouthpiece.

17. The aerosol-generating cartridge of claim 16, wherein the air inlet is disposed at a longitudinal position between the longitudinal positions of the heater and the aerosol outlet.

18. The aerosol-generating cartridge of claim 16, wherein the air inlet is disposed at a longitudinal position between the longitudinal positions of the heating element and the aerosol outlet.

19. The aerosol-generating cartridge of claim 16, wherein the mouthpiece defines an aerosol pathway from the heater to the aerosol outlet, the aerosol pathway being substantially straight.

20. The aerosol-generating cartridge of claim 16, wherein the mouthpiece defines an aerosol pathway, which passes directly from heating element to the aerosol outlet.

21. The aerosol-generating cartridge of claim 16,
wherein the mouthpiece further comprises a mouthpiece insert defining the aerosol pathway,
wherein the mouthpiece housing comprises an outer wall, and
wherein the mouthpiece insert is attached to the outer wall.

22. The aerosol-generating cartridge of claim 16, wherein the porous body comprises a porous ceramic.

23. The aerosol-generating cartridge of claim 16, wherein the heater is disposed at or towards the connection end of the cartridge.

24. The aerosol-generating cartridge of claim 16, wherein the heater is arranged substantially centrally within the mouthpiece housing width.

25. The aerosol-generating cartridge of claim 16, wherein the mouthpiece housing is tapered such that the aerosol outlet end has a smaller area than an area of the connection end.

26. The aerosol-generating cartridge of claim 16, wherein the cartridge is configured for attachment to a device such that the air inlet is defined between the cartridge and the device.

27. An aerosol-generating system, comprising:
the aerosol-generating cartridge according to claim 16; and
an aerosol-generating device configured to provide electrical power to the heater of the aerosol-generating cartridge.

28. The aerosol-generating system according to claim 27, further comprising at least two air inlets, each provided between the cartridge and the device.

29. The aerosol-generating system according to claim 28, wherein the at least two air inlets are provided between the cartridge and the device, and are separated from each other by the width of the cartridge.
